(19) United States
(12) Patent Application Publication
(10) Pub. No.: US 2016/0318594 A1
(43) Pub. Date: Nov. 3, 2016

(54) FUSELAGE SECTION AND TRANSVERSE BUTT JOINT CONNECTING TWO FUSELAGE SECTIONS OF AN AIRCRAFT OR SPACECRAFT

(71) Applicant: Airbus Operations GmbH, Hamburg (DE)

(72) Inventor: Carsten Paul, Hamburg (DE)

(21) Appl. No.: 15/141,078

(22) Filed: Apr. 28, 2016

(30) Foreign Application Priority Data
Apr. 30, 2015 (DE) 102015208024.2

(51) Int. Cl. B64C 1/06; B64F 5/00

(52) U.S. Cl. CPC B64C 1/069; B64C 1/064; B64F 5/0009

(57) ABSTRACT

A fuselage section of an aircraft or spacecraft includes a stringer, an outer skin on the inside of which the stringer is arranged, and a stringer coupling. The stringer coupling includes a first coupling portion, by means of which the stringer coupling is connected to the stringer at a head end of the stringer, and a second coupling portion which is planar and by means of which the stringer coupling is connected to the outer skin so as to overlap the head end of the stringer in the longitudinal direction of the stringer. The second coupling portion has a wider surface area than the first coupling portion and the stringer, such that the stringer is widened beyond the head end in the longitudinal direction by means of the stringer coupling.

### CROSS-REFERENCES TO RELATED APPLICATIONS

This application claims the benefit of the German patent application No. 102015208024.2 filed on Apr. 30, 2015, the entire disclosures of which are incorporated herein by way of reference.

### FIELD OF THE INVENTION

The present invention relates to a fuselage section of an aircraft or spacecraft and to a transverse butt joint connecting two fuselage sections of this kind.

### BACKGROUND OF THE INVENTION

Although it can be used in any desired aircraft and spacecraft, the present invention and the underlying problem thereof will be described in more detail with respect to passenger aircraft.

Fuselages of passenger aircraft are frequently produced in an aluminum construction method from high-strength aluminum alloys, a plurality of prefabricated barrel-shaped fuselage sections being joined together to form an aircraft fuselage cell. Each fuselage section is formed having a plurality of annular formers that are arranged behind one another, extend in the peripheral direction and are planked with an outer skin. In addition, the fuselage sections comprise elongate stringers that extend substantially in parallel with the longitudinal axis of the fuselage section and are arranged at regular spacings over the periphery on an inner face of the outer skin. In this case, both the stringers and the formers function in particular as a reinforcing frame for stabilizing the fuselage sections. The annular formers can be connected to the outer skin by means of a thrust vane that comprises a plurality of openings through which the stringers lead. Furthermore, the annular formers, the stringers and the outer skin are typically, in addition, interconnected by means of a plurality of gusset plates, known as clips. In reality, all these components are typically interconnected by means of a plurality of rivet connections.

The connection points of the individual fuselage sections are referred to as transverse butts or transverse butt seams. The connection between two fuselage sections at a transverse butt of this kind can be produced by means of a transverse butt strap. In this case, this is typically a peripheral metal sheet several millimeters thick that is riveted on each side in the peripheral direction to the outer skin of one of the two fuselage sections respectively. For reasons of stability, in particular for pressure stability, transverse butt seams of this kind are often positioned in the longitudinal direction such that the transverse butt strap can be coupled on the inside to a former or thrust vane lying thereover. It order for it to be possible for longitudinal forces along the stringer to be simultaneously transferred via the transverse butt seam, the stringers can be directly coupled to one another via the transverse butt seam by means of what are known as stringer couplings, for example through the openings in the thrust vane. Alternatively, the stringers can be connected to the former, for example also by means of couplings, such that the longitudinal forces can be transferred via the former.

When manufacturing aircraft fuselages, it is advantageous for it to be possible to assemble the transverse butts as quickly and simply as possible, so that the processing time or immobilization time can be kept as short as possible during assembly. This can be promoted, in particular, by the transverse butts being easily accessible and requiring only a little riveting work for fastening. If a transverse butt is under a former, a number of interfering contours arise when riveting the transverse butt strap on account of the various individual components, which contours can make rapid assembly more difficult. Moreover, the fuselage sections must be oriented towards one another. In this case, the stringers of the fuselage section in question must also be oriented relative to the stringers of the other fuselage section.

### SUMMARY OF THE INVENTION

Against this background, one idea of the present invention is that of providing a simple option for connecting fuselage sections that can be assembled quickly and using few connecting elements.

A fuselage section comprises a stringer, an outer skin on the inside of which the stringer is arranged, and a stringer coupling. The stringer coupling comprises a first coupling portion, by means of which the stringer coupling is connected to the stringer at a head end of the stringer. The stringer coupling further comprises a second coupling portion which is planar and by means of which the stringer coupling is connected to the outer skin so as to overlap the head end of the stringer in the longitudinal direction of the stringer. The second coupling portion has a wider surface area than the first coupling portion and the stringer, such that the stringer is widened beyond the head end in the longitudinal direction by means of the stringer coupling.

In addition, a transverse butt joint is provided connecting two fuselage sections according to the invention. The transverse butt joint comprises a transverse butt strap that is formed having a first transverse joint portion and a second transverse joint portion. The transverse butt strap is connected to the outer skin of one of the two fuselage sections by means of the first transverse joint portion, and to the outer skin of the other of the two fuselage sections by means of the second transverse joint portion. The transverse butt strap further comprises a web that is arranged centrally on the transverse butt strap, extending in the peripheral direction in the manner of a former, between the first transverse joint portion and the second transverse joint portion. The stringers of the fuselage sections face one another in pairs in each case on either side of the web, and are each oriented, together with the stringer coupling, towards the web for the purpose of longitudinal force transfer.

A concept on which the present invention is based comprises providing a transverse butt joint connecting two fuselage sections in the free outer skin region, without the need for an internal former at the transverse butt joint. The transverse butt is thus automatically easily accessible and can be assembled using few connecting elements. Thus, in particular, little riveting work is necessary for example, since there are far fewer components to be riveted than in conventional transverse butts. This results in a shorter processing time or immobilization time when assembling the fuselage, which in turn saves significant amounts of time and money.

The invention is based on two fundamental findings. Firstly, transverse forces transmitted along the stringer can be introduced into the planking, i.e., the outer skin, in a planar manner and can be conducted away therefrom in that the stringers are “fanned out” by means of a special coupling and are coupled to the outer skin over a wide surface area. Longitudinal forces along a stringer can thus be introduced in a planar manner from a stringer into an outer skin. Correspondingly, forces can also be conducted away from the outer skin in a planar manner along the longitudinal sides into the stringer. Using a stringer coupling of this kind on both sides of the transverse butt joint means that separate couplings of the stringer via the transverse butt can be omitted. In particular, the stringers are not brought into a constrained position when orienting the fuselage sections, and remain in their positions. The stringer coupling according to the invention absorbs the forces from the stringers and carries the forces away, over a large surface area, into the transverse butt strap via the transverse seam. Conversely, the forces are then absorbed again, over a wide surface area, by the opposing stringer coupling and transferred into the opposing stringer. Separate couplings or shims can be omitted on account of this stringer coupling according to the invention. In addition, very expensive structural variations can be reduced, which variations occur, for example, on account of the precise orientation of the stringers that is usually required.

Secondly, the former that is present in conventional transverse butt joints can be replaced by a simple web that is positioned centrally on the transverse butt strap and opposes the internal pressure. The web can, for example, already be fastened to the transverse butt strap or connected thereto before assembling the transverse butt joint, with the result that only the transverse butt strap needs to be connected to the outer skin of two fuselage sections in order to assemble the transverse butt joint. A combination of these two findings permits a transverse butt joint in the free skin region that is simple and quick to assemble but nonetheless permits good stability of the connection.

Advantageous embodiments and developments are set out in the further dependent claims and in the description with reference to the figures.

According to a development of the fuselage section, the second coupling portion can have a maximum width BK in the peripheral direction. The stringer can have a maximum width BS in the peripheral direction. The maximum width BK of the second coupling portion and the maximum width BS of the stringer can be associated with the factor k by the relation B_{K}≧k×B_{S}. In this case, the factor k can be greater than or equal to 3. In particular, the factor k can be equal to 4, 5 or 6 or a larger whole or real number. This development establishes that the stringer coupling effectively widens the stringer by a certain minimum width. As a result, an optimal widening of the stringer can be established for the use in question, such that the longitudinal forces can be optimally introduced in a planar manner into the transverse butt strap and can be conducted away therefrom in a planar manner.

According to a development of the fuselage section, the stringer coupling can be T-shaped, so that the first coupling portion of the stringer coupling is connected to the stringer in a substantially parallel manner in the form of the crosspiece of a T, and the second coupling portion of the stringer coupling is connected to the outer skin in the form of two legs of a T that protrude substantially at right angles from the crosspiece of the T. This development is an embodiment of the stringer coupling given by way of example that permits planar force introduction from a stringer into an outer skin. In this case, the stringer coupling is effectively in the form of a “hammer,” the “shaft” of the hammer permitting a narrow direct connection to the stringer, and the “head” of the hammer forming a planar connection to the outer skin. In this case, the width of the legs of the T can be selected such that the width of the stringer coupling on the outer skin is many times greater than the actual width of the stringer, with the result that the stringer is widened by many times its original width. Depending on the application, the two legs of the T can be designed so as to be symmetrical or asymmetrical.

The first coupling portion of the stringer coupling can be riveted to the head end of the stringer. The second coupling portion of the stringer coupling can be riveted to the outer skin. Thus, the stringer coupling can be a component made of metal or a metal alloy or the like, for example, that can be riveted to the stringer and the outer skin in a simple manner.

The second coupling portion of the stringer coupling can be riveted to the outer skin on both sides of the stringer by means of at least two rows of rivets in each case that extend in parallel with the stringer. Depending on the configuration of the rivets used, the number of rows of rivets defines the widening of the stringer by the stringer coupling. Furthermore, by means of the orientation of the rows of rivets, the stringer coupling can influence the direction or manner in which the longitudinal forces are introduced or carried away.

For example, the second coupling portion of the stringer coupling can be riveted to the outer skin by means of at least five rows of rivets extending in parallel with the stringer.

The first coupling portion of the stringer coupling can be riveted to the stringer by means of a row of rivets extending in the longitudinal direction. In an embodiment, the first coupling portion can have approximately the same width as the stringer, for example, and can be connected thereto by means of a row of rivets. The second coupling portion, on the other hand, can be designed to be significantly wider, i.e., be approximately five times the width of the stringer, and can be riveted to the outer skin by means of five or more rows of rivets extending in parallel with the stringer.

According to a development, the stringer coupling can be formed in one piece. In this development, the stringer coupling is consequently particularly simple to assemble on a stringer and an outer skin.

A plurality of stringers that are evenly distributed and are arranged in parallel with one another can each be connected to the outer skin by means of one stringer coupling respectively. The stringer coupling according to the invention can be used for a plurality of or for all the stringers located on the inner face of an outer skin of a fuselage section.

According to a development of the transverse butt joint, the first transverse joint portion and/or the second transverse joint portion can be spliced in the longitudinal direction of the fuselage sections. This means that the thickness of the transverse butt joint portions can vary in the radial direction and different thicknesses of the outer skin can be compensated on either side of the transverse butt strap. When there are different planking thicknesses, shims are usually assembled under the transverse butt strap in order to compensate the unequal relationship of the thicknesses. This development has the advantage that different planking thicknesses can be directly incorporated into the transverse butt strap. This makes it possible to further speed up the assembly of a transverse butt joint.

The transverse butt strap can be an extruded profile. In this development, transverse butt straps can be produced having a significantly greater strength than that provided by the conventional sheet metal profiles, for example. The transverse butt strap can already be formed having spliced transverse joint portions during extrusion, in order to compensate different planking thicknesses.

The web can be designed as a T-profile. The T-profile can be riveted to the transverse butt strap. The transverse butt strap can be an extruded profile made of aluminum or an aluminum alloy, for example (or alternatively made of another metal such as titanium, etc.), to which a T-shaped web made of the same material is riveted.

According to a development of the transverse butt joint, the second coupling portions of the stringer couplings can be riveted to the transverse butt strap. In this development, the stringer couplings can introduce occurring longitudinal forces directly into the transverse butt strap and transfer the forces via the strap.

The configurations and developments above can be combined with one another as desired where appropriate. Further possible configurations, developments and implementations of the invention also include not explicitly mentioned combinations of features of the invention which have been described previously or are described in the following with reference to the embodiments. In particular, in this case, a person skilled in the art will also add individual aspects as improvements or supplements to each basic form of the present invention.

### BRIEF DESCRIPTION OF THE DRAWINGS

In the following, the present invention will be described in more detail with reference to the embodiments shown in the schematic figures, in which:

FIG. 1a is a schematic side view of a fuselage by way of example that is composed of a plurality of fuselage sections;

FIG. 1b is a schematic perspective view of the assembly of a transverse butt joint by way of example between two fuselage sections from FIG. 1a by means of a transverse butt strap;

FIG. 1c is a schematic cross-sectional view of the transverse butt joint by way of example from FIG. 1b in the assembled state;

FIG. 2a is a schematic plan view of a transverse butt joint connecting two fuselage sections according to an embodiment of the invention;

FIG. 2b is a schematic side view of the transverse butt joint from FIG. 2a;

FIG. 3a is a schematic exterior side view of a fuselage comprising a transverse butt joint according to a further embodiment of the invention;

FIG. 3b is a schematic side view of the transverse butt joint from FIG. 3a inside the fuselage;

FIG. 3c is a schematic side view of a transverse butt strap of the transverse butt joint from FIG. 3b; and

FIG. 3d is a schematic side view of a transverse butt strap of a transverse butt joint according to a further embodiment of the invention.

### DETAILED DESCRIPTION OF THE PREFERRED EMBODIMENTS

The accompanying figures are intended to provide further understanding of the embodiments of the invention. They illustrate embodiments and are used, in conjunction with the description, to explain principles and concepts of the invention. Other embodiments and many of the mentioned advantages are revealed in the drawings. The elements of the drawings are not necessarily shown true to scale in relation to one another.

In the drawings, identical, functionally identical and identically functioning elements, features and components have been provided with the same reference numerals in each case, unless indicated otherwise.

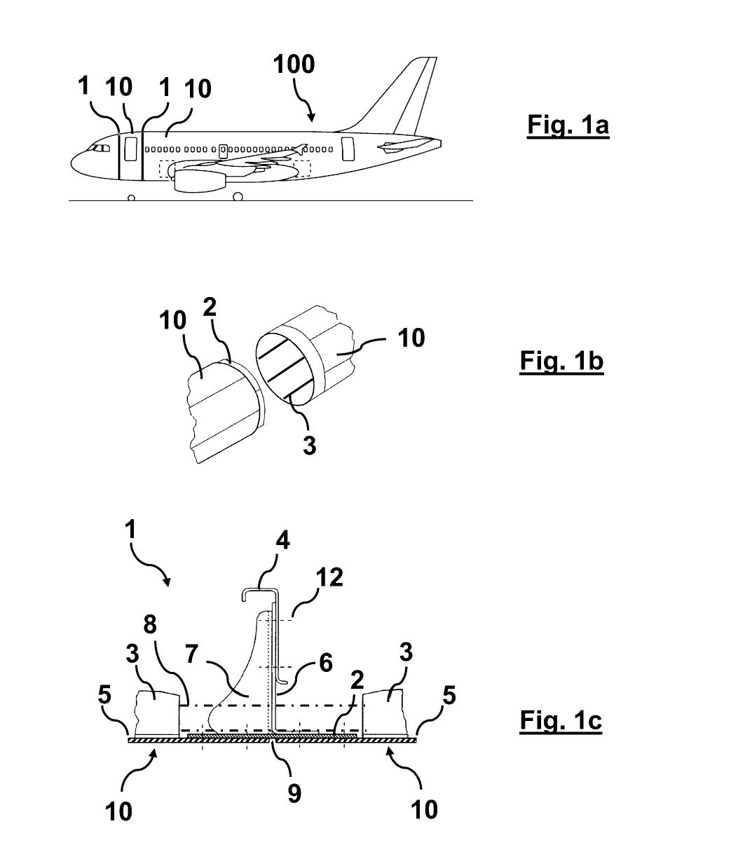

FIG. 1a to FIG. 1c show, by way of example, how a fuselage can be composed of a plurality of fuselage sections. In FIG. 1a, reference sign 100 in this case denotes a passenger aircraft that is constructed from a plurality of fuselage sections 10 that are coupled together by means of transverse butt joints 1 (two examples are shown schematically in FIG. 1a). FIG. 1b shows, by way of example and schematically, how two fuselage sections 10 are interconnected by means of a transverse butt strap 2. A plurality of stringers 3, given by way of example, are shown in FIG. 1b for the purpose of illustration. Finally, FIG. 1c is a cross-sectional view of the schematic construction of a transverse but joint 1, by way of example, that connects two fuselage sections 10. The fuselage sections 10 each comprise a stringer 3 that is attached to an outer skin 5. The two outer skins 5 are coupled by means of a thin transverse butt strap 2, above which a former 4 is arranged by means of a thrust vane 6 and clip 7. Rivet connections 12 couple the individual components to one another and couple the transverse butt strap 2 to the outer skins 5. In this case, the two stringers 3 can be directly coupled to one another through the thrust vane 6 by means of a stringer coupling 8. The course of a stringer coupling 8 of this kind is shown schematically in FIG. 1c by a dot-dash line.

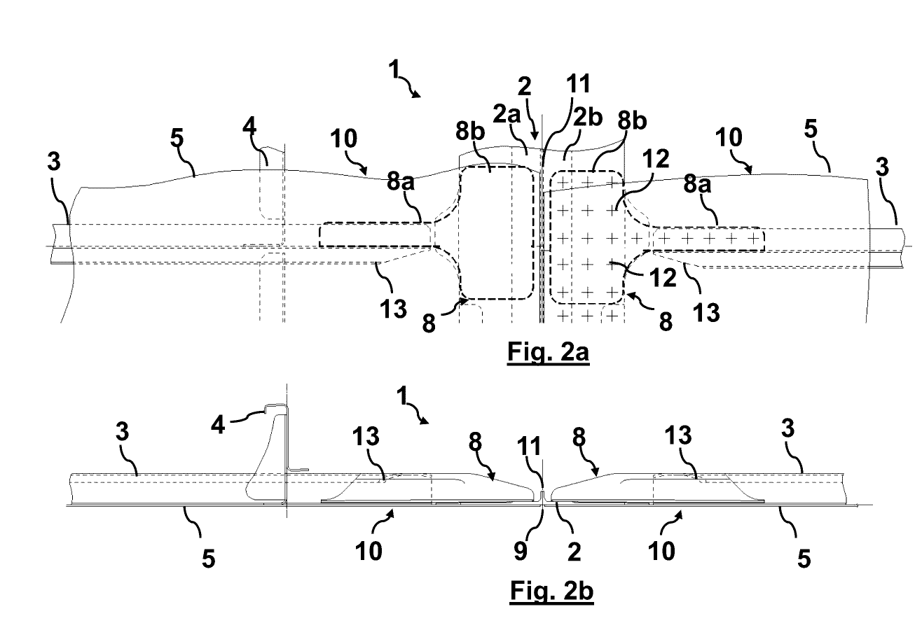

FIG. 2a is a schematic plan view of a transverse butt joint connecting two fuselage sections according to an embodiment of the invention. FIG. 2b is a schematic side view of the same transverse butt joint.

In FIG. 2a and FIG. 2b, the reference numeral 1 denotes the transverse butt joint. The transverse butt joint 1 connects two fuselage sections 10 of an aircraft 100 (not shown) by means of a transverse butt strap 2. The transverse butt strap is a planar extruded component that is riveted at a first transverse joint portion 2a to one fuselage section 10 and is riveted at a second transverse joint portion 2b to the other fuselage section 10. Both fuselage sections 10 are in principle barrel-shaped and have formers 4 extending in the peripheral direction and stringers 3 extending in the longitudinal direction that are planked by an outer skin 5, the stringers 3 and formers 4 being riveted to the outer skin. In each case, the formers 4 and stringers 3 reinforce the fuselage sections 10 in the transverse and longitudinal directions respectively. One stringer 3 of this kind is shown by way of example for each fuselage section 10. A former 4 is in addition shown by way of example in the fuselage section on the left-hand side in FIG. 2a. In principle, each fuselage section 10 comprises a plurality of such springers 3 and formers 4 that are arranged in parallel with one another at regular spacings on the inside of the outer skin 5. The fuselage sections 10 can be manufactured in an aluminum construction process for example. In principle, however, the invention can also be used for fuselage sections 10 made of any desired material. Thus, the fuselage sections can for example also comprise or consist of fiber composite materials such as glass-reinforced aluminum (GLARE®) or carbon fiber reinforced plastics material (CFRP), or other metals or metal alloys. Depending on the material, rivet connections 12 may need to be replaced by corresponding suitable connecting elements or connection method. However, the basic concepts and principles of the present invention can otherwise be applied correspondingly to fuselage sections 10 of this kind.

The stringers 3 of both fuselage sections 10 are oriented facing one another in pairs in each case along the transverse butt joint 1, i.e., the transverse butt strap 2. The stringers 3 end in each case at a head end 13 before the transverse butt strap 2. The stringers 3 are in each case connected by means of a stringer coupling 8 to the outer skin 5 of the fuselage section 10 in question and to the transverse butt strap 2. The stringer coupling 8 is designed as a strap and comprises a first coupling portion 8a by means of which the stringer coupling 8 is riveted to the stringer 3 at the head end 13 of the stringer 3. The stringer coupling 8 further comprises a second coupling portion 8b by means of which the stringer coupling 8 is riveted to the outer skin 5 in question or to the transverse butt strap 2 so as to overlap the head end 13 of the stringer 3 in the longitudinal direction of the stringer 3. A plurality of rivet connections 12 is shown by way of example for the stringer coupling 8 of the right-hand stringer 3 in FIGS. 2a and 2b. The stringer coupling 8 is in particular T-shaped. In this case, the first coupling portion 8a of the stringer coupling 8 forms the crosspiece of the T and is connected to the stringer 3 in a substantially parallel manner. The second coupling portion 8b of the stringer coupling 8 forms the two legs of the T that protrude substantially at right angles from the crosspiece of the T. The first coupling portion 8a is riveted to the stringer 3 or the head end 13 of the stringer 3 by means of a row of rivets. Conversely, the second coupling portion 8b has a significantly wider surface area than the first coupling portion 8a, with the result that the second portion is riveted to the outer skin 5 or the transverse butt strap 2 by means of a total of five parallel rows of rivets. The second coupling portion 8b widens the stringer 3 beyond the head end 13 in the longitudinal direction by many times the actual width of the stringer. In this embodiment, the actual width of the stringer 3 corresponds to approximately one row of rivets, meaning that the stringer coupling 8 effectively widens the stringer 3 at the head end 13 thereof to approximately five times its original width. However, the present invention is not restricted to this specific configuration of the stringer coupling. It is important in this case for the stringer coupling 8 to be designed to be many times wider in the second coupling portion 8b than in the first coupling portion 8a. For example, the second coupling portion 8b can accordingly also alternatively comprise 7 rows of rivets, while the first coupling portion 8a is still the width of one row of rivets. The specific width of a row of rivets is ultimately determined by the dimensions of the rivets 12 used.

The connection according to the invention between the stringer 3 and the outer skin 5 or the transverse butt strap 2 over a wide surface area allows occurring longitudinal forces along the stringer 3 to be introduced in a planar manner from the stringer 3 into the outer skin 5 or the transverse butt strap 2. Correspondingly, forces are also conducted away from the outer skin 5 or transverse butt strap 2 in a planar manner into the respective stringer 3. The specific manner in which the longitudinal forces are transferred can be seen from FIG. 2a. For example, the right-hand stringer 3 absorbs longitudinal forces and transfers the forces into the transverse butt joint 1 or the transverse butt strap 2 via the stringer coupling 8. In this case, the forces from the first coupling portion 8a are fanned out on the second coupling portion 8b and introduced in a planar manner into the transverse butt strap 2. Correspondingly, the forces are absorbed again by the left-hand stringer 3 in FIG. 2b in a planar manner at the corresponding second coupling portion 8b and are transferred in the longitudinal direction of the stringer 3 via the first coupling portion 8a. There is therefore no direct coupling between the left-hand and right-hand stringers 3 in the present embodiment of the invention, and therefore the transfer of the longitudinal forces is particularly simple in this embodiment.

This particularly simple stringer coupling to the transverse butt creates the possibility of positioning the transverse butt joint 1 in a free skin region of the fuselage, i.e., without a former 4 having to be positioned precisely over the transverse seam. The transverse butt joint 1 is thus particularly easy to access and assemble. In particular, little riveting work is necessary since far fewer components need to be riveted than in the case of conventional transverse butt joints 1. This results in a shorter processing time or immobilization time when assembling the fuselage, which in turn saves a significant amount of time and money.

In the present embodiment, the transverse butt strap 2 itself comprises a web 11. The web 11 is a T-shaped aluminum profile that is riveted to the transverse butt strap 2. Alternatively, the web 11 can also be formed in one piece, i.e., integrally, with the transverse butt strap 2. The web 11 is arranged centrally on the transverse butt strap 2, between the first transverse joint portion 2a and the second transverse joint portion 2b. Furthermore, the web 11 is oriented substantially perpendicularly on the transverse butt strap 2 on the inside of the fuselage, and extends along the transverse butt strap 2 in the peripheral direction in the manner of a former 4. In this respect, the web 11 effectively assumes the function of a former 4, although it has the significant advantage of being able to already be produced together with the transverse butt strap 2 before the transverse butt joint 1 is assembled. When assembling the transverse butt strap 2 it is thus only necessary to orient the two fuselage sections 10 relative to one another and to rivet the outer skin 5 thereof to the transverse butt strap 2. In conventional transverse butt joints, however, a plurality of further components must be labor-intensively taken into account and riveted or otherwise connected in a complex manner. The transverse butt strap 2 itself is an extruded profile and thus has a significantly higher strength than the sheet metal profiles conventionally used. The position of the transverse butt seam between the formers 4, i.e., in the free skin region, and the particular configuration of the transverse butt strap 2 result in good accessibility for riveting work without corresponding interfering contours, meaning that significant amounts of time and money can be saved when assembling the fuselage.

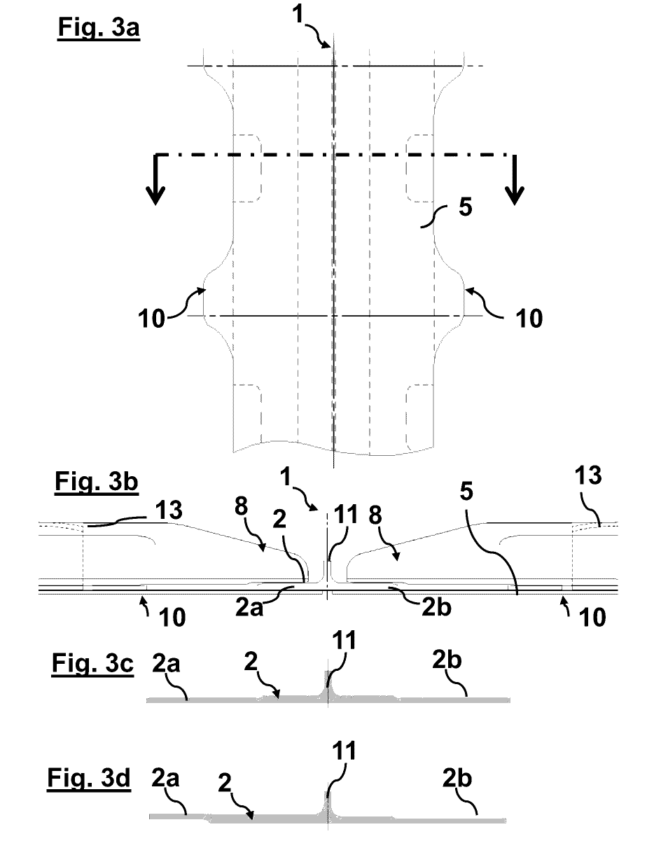

FIG. 3a is a schematic exterior side view of a fuselage comprising a transverse butt joint 1 according to a further embodiment of the invention. The outer skin 5 of two fuselage sections can be seen in the figure. In addition, FIG. 3b is a schematic side view of the transverse butt joint 1 form FIG. 3a inside the fuselage. In this case, the embodiment of the transverse butt joint 1 corresponds to that from FIG. 2a and FIG. 2b. FIG. 3c is a schematic side view of the transverse butt strap 2 of the transverse butt joint 1 from FIG. 3b, the first transverse joint portion 2a and the second transverse joint portion 2b being indicated. In this embodiment, the two transverse joint portions 2a, 2b are symmetrical. FIG. 3d is a schematic side view of a transverse butt strap 2 of a transverse butt joint 1 according to a further embodiment of the invention. In this case, the transverse butt strap 2 is spliced and the two transverse joint portions 2a, 2b are asymmetrical. A transverse butt strap 2 of this kind makes it possible to compensate different thicknesses of the outer skin 5 without it being necessary to assemble additional shims or the like. Rather, the different thicknesses can be incorporated directly into the transverse butt strap 2. This can be achieved without much outlay by means of extrusion, for example.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fuselage section of an aircraft or spacecraft, comprising:
a stringer;
an outer skin on the inside of which the stringer is arranged; and
a stringer coupling that comprises a first coupling portion, by means of which the stringer coupling is connected to the stringer at a head end of the stringer, and comprises a second coupling portion which is planar and by means of which the stringer coupling is connected to the outer skin so as to overlap the head end of the stringer in the longitudinal direction of the stringer,
wherein the second coupling portion has a wider surface area than the first coupling portion and the stringer, such that the stringer is widened beyond the head end in the longitudinal direction by means of the stringer coupling.

2. The fuselage section of claim 1, wherein the second coupling portion has a maximum width B_{K} in the peripheral direction and the stringer has a maximum width B_{S} in the peripheral direction, which widths are associated with the factor k by the relation B_{K}≧k×B_{S}, wherein the factor k is greater than or equal to 3.

3. The fuselage section of claim 1, wherein the stringer coupling is T-shaped, so that the first coupling portion of the stringer coupling is connected to the stringer in a substantially parallel manner in the form of a crosspiece of a T, and the second coupling portion of the stringer coupling is connected to the outer skin in the form of two legs of a T that protrude substantially at right angles from the crosspiece of the T.

4. The fuselage section of claim 1, wherein the first coupling portion of the stringer coupling is riveted to the head end of the stringer and the second coupling portion of the stringer coupling is riveted to the outer skin.

5. The fuselage section of claim 1, wherein the second coupling portion of the stringer coupling is riveted to the outer skin on both sides of the stringer by means of at least two rows of rivets in each case that extend in parallel with the stringer.

6. The fuselage section of claim 1, wherein the second coupling portion of the stringer coupling is riveted to the outer skin by means of at least five rows of rivets extending in parallel with the stringer.

7. The fuselage section of claim 1, wherein the first coupling portion of the stringer coupling is riveted to the stringer by means of a row of rivets extending in the longitudinal direction.

8. The fuselage section of claim 1, wherein the stringer coupling is formed in one piece.

9. The fuselage section of claim 1, wherein a plurality of stringers that are evenly distributed and are arranged in parallel with one another are each connected to the outer skin by means of one stringer coupling, respectively.

10. A transverse butt joint connecting two fuselage sections of an aircraft or spacecraft, the fuselage sections each comprising:
a stringer;
an outer skin on the inside of which the stringer is arranged; and
a stringer coupling that comprises a first coupling portion, by means of which the stringer coupling is connected to the stringer at a head end of the stringer, and comprises a second coupling portion which is planar and by means of which the stringer coupling is connected to the outer skin so as to overlap the head end of the stringer in the longitudinal direction of the stringer, the second coupling portion having a wider surface area than the first coupling portion and the stringer, such that the stringer is widened beyond the head end in the longitudinal direction by means of the stringer coupling,
the butt joint further comprising:
a transverse butt strap that is formed having a first transverse joint portion and a second transverse joint portion, wherein the transverse butt strap is connected to the outer skin of one of the two fuselage sections by means of the first transverse joint portion, and to the outer skin of the other of the two fuselage sections by means of the second transverse joint portion, and comprises a web that is arranged centrally on the transverse butt strap, extending in the peripheral direction in the manner of a former, between the first transverse joint portion and the second transverse joint portion,
wherein the stringers of the fuselage sections face one another in pairs in each case on either side of the web, and are each oriented, together with the stringer coupling, towards the web for the purpose of longitudinal force transfer.

11. The transverse butt joint of claim 10, wherein at least one of the first transverse joint portion or the second transverse joint portion are spliced in the longitudinal direction of the fuselage sections.

12. The transverse butt joint of claim 10, wherein the transverse butt strap is an extruded profile.

13. The transverse butt joint of claim 10, wherein the web is designed as a T-profile that is riveted to the transverse butt strap.

14. The transverse butt joint of claim 10, wherein the second coupling portions of the stringer couplings are riveted to the transverse butt strap.

15. An aircraft or spacecraft comprising a transverse butt joint, connecting two fuselage sections of an aircraft or spacecraft, the fuselage sections each comprising:
a stringer;
an outer skin on the inside of which the stringer is arranged; and
a stringer coupling that comprises a first coupling portion, by means of which the stringer coupling is connected to the stringer at a head end of the stringer, and comprises a second coupling portion which is planar and by means of which the stringer coupling is connected to the outer skin so as to overlap the head end of the stringer in the longitudinal direction of the stringer, the second coupling portion having a wider surface area than the first coupling portion and the stringer, such that the stringer is widened beyond the head end in the longitudinal direction by means of the stringer coupling,
the butt joint further comprising:
a transverse butt strap that is formed having a first transverse joint portion and a second transverse joint portion, wherein the transverse butt strap is connected to the outer skin of one of the two fuselage sections by means of the first transverse joint portion, and to the outer skin of the other of the two fuselage sections by means of the second transverse joint portion, and comprises a web that is arranged centrally on the transverse butt strap, extending in the peripheral direction in the manner of a former, between the first transverse joint portion and the second transverse joint portion,
wherein the stringers of the fuselage sections face one another in pairs in each case on either side of the web, and are each oriented, together with the stringer coupling, towards the web for the purpose of longitudinal force transfer.
